(19) United States
(12) Patent Application Publication
(10) Pub. No.: US 2010/0132320 A1
(43) Pub. Date: Jun. 3, 2010

(54) Air pollution dry cleaning apparatus

(76) Inventor: Ali Sharifi, New york, NY (US)

Correspondence Address: Ali Sharifi, 240 East 55th Street, #11B, New York, NY, 10022, US

(21) Appl. No.: 12/694,941

(22) Filed: Jan. 27, 2010

(51) Int. Cl. B01D 29/60; B01D 29/56

(52) U.S. Cl. 55/473

(57) ABSTRACT

An air pollution control system comprising of a metal barrel-like housing with an in-take portion securely attached to top of industrial chimney or on the smoke chimney on the roofs of residential buildings, and an outlet portion, three electrical fans, the first two of which blow the polluted air coming from the chimney toward filter means installed after each fan, and a third fan blowing the cleaned air to the atmosphere. The said housing has a moveable door to be removed or pushed aside for cleaning the fans and/or filter means and replacing the filters regularly.

### BACKGROUND OF THE INVENTION

1. Field of the Invention

The present invention relates to a method of and process for removing pollutants from the smoke emitted from the industrial chimneys and/or from the exhaust pipes on roofs of residential buildings

2. Description of the prior Art

The reliance on oil and coal has resulted in the unwanted production of many pollutants and the pollutants from the smoke emitted from the chimneys are known to contribute significantly to atmospheric pollution and, therefore, substantial attention has been given to the control of air pollution. As people have become more environment-conscious, the elimination of pollutants has become increasingly important in order to control air pollution

Over the last several decade, several means have been attempted to alleviate the problem of air pollution by removing undesirable particular matter from gaseous processing streams and exhausts, and several techniques for cleaning up or eliminating pollutants from gases have been proposed. Among these is filtration. U.S. Pat. Nos. 3,876,402 granted to Bundy, et al. on Apr. 8, 1975, 3,917,458 to Polak on Nov. 4, 1975, 4,957,519 to Chen on Sep. 18, 1990, 5,199,362 to Carter on Apr. 16, 1993, and 6,511,637 to Bundy on Jan. 28, 2003 disclose apparatus and methods used to filter pollutants from chimneys. These inventions use filter as the means to purify the air from pollutants. While the above-mentioned devices fulfill their respective particular objectives, they have not solved the continuous problem of air pollution. Other techniques proposed involve the use of cyclone separators, electrostatic precipitators, wet scrubbers, and molten gas scrubbers. Cyclones are very inefficient in separating particles of a size below five microns. Electrostatic precipitators have been rejected because of cost, size and lack of flexibility and they are inefficient. Furthermore, they are only effective for the removal of the particular matter that comprises fly ash and not for the removal of gaseous pollutants, such as carbon dioxide, sulphur and dioxide or mercury.

Wet scrubbers are useful primarily for the removal of sulphur dioxide and not for the removal of other gaseous pollutants, such as carbon dioxide, or mercury. Molten glass scrubbers have the disadvantage that the ratio of glass to collected materials is in the ten to one range which makes the process expensive.

Many techniques use one or more materials to remove another material from the gas stream. For example, to remove mercury, U.S. Pat. No. 6,962,617 dated Nov. 8, 2005 granted to Simpson used a sorbent material like hydrogen mordenite or hydrogen clinoptilolite, and U.S. Pat. No. 6,960,329 dated Nov. 1, 2005 to Sellakumar feeds the gases with a solution containing chloride-containing salt, and U.S. Pat. No. 6,878,358 dated Apr. 12, 2005 to Vosteen, et al. uses a bromine compound and U.S. Pat. No. 6,855,859 dated Feb. 15, 2005 to Nolan, et al. uses chlorine and sulfide species separately, and U.S. Pat. No. 6,790,420 dated Sep. 14, 2004 to Breen, et al. uses ammonia and optionally carbon monoxide, all to extract mercury. The question which is not addressed in any of the above-mentioned patents and many that are not mentioned here is that what happens as a result of the combination of the above materials with mercury. Most probably, the result of the combination of the above material with mercury is some vapors that spread to the atmosphere and create more pollution problems that were not anticipated.

Many others, if not the majority of techniques use water or water spray to ‘wash” the pollutants from the gas stream. Among these could be mentioned U.S. Pat. Nos. 4909161 dated Mar. 20, 1990 granted to Germain, 5,358,552 dated Oct. 25, 1994 to Seibert, et al., 6,627,166 dated Sep. 30, 2003 to Simon, 5,199,362 dated Apr. 6, 1993 to Carter and many others which use water for cleaning the pollutants from the gases. The combination of water with substances like nitrogen oxides and sulphur dioxide produce highly corrosive acids and need depuration in order to separate the solid residual substances carried by them, and in order to chemically modify at least the more polluting substances contained therein. To this purpose, some apparatuses such as electrostatic, liquid flow separators, filters, cyclones, gas supplied afterburners and catalytic afterburners have been proposed. However, in most cases the installation and management costs of such purifying apparatuses are unsustainable and, on the other hand, their effectiveness is not satisfactory in the general applications. Furthermore, the fumes which are discharged from the heat exchanger device are saturated with water vapor, and the harmful pollutants still present are in solution in water droplets. It is, therefore, necessary to install downstream from the heat exchanger device, another device for the removal of vesicles which capture the droplets being released from this exchanger. The vesicle-removal device, which may be a Venturi tube, uses excessive amount of energy and easily becomes clogged with soot. To do without this vesicle-removal device, different installation arrangements have been suggested, all of which are based on the reheating of the fumes before releasing them into the atmosphere in a non-saturated state. In any event, the installation of the vesicle-removal device or the reheating system is complicated, burdensome, and difficult to maintain.

As can be appreciated from the above, an urgent need exists for a new and improved air pollution prevention system that answers the immediate need of preventing air pollution resulting from the spread of gaseous pollutants into the atmosphere, and, at the same time, is cost effective, simple and practical. This improvement is the object of the present invention. The present invention overcomes the problems of the prior art mentioned above, and provides other advantages that have not been realized before. To this effect, the present invention substantially fulfills this need, and, particularly, the present invention substantially departs from the conventional concept and analysis of the prior art in terms of its simplicity, practicality, and the low cost of materials used, of installation and maintenance. Furthermore, the advantage of the present invention are that the cleaning and/or replacement of the filters and the cleaning of the fans and the entire interiors of the housing are easy and practical. By removing the door or sliding it to the side, all parts are exposed and accessible for cleaning and/or replacement. The process of the present invention eliminates the need for present reduction technologies which are extremely expensive to manufacture, install and maintain, and does not have the drawbacks mentioned above. Using the present invention makes it possible to replace the filter elements and cleaning the fans without additional equipment, and to eliminate the need for additional complex, bulky, ineffective and expensive cleaning equipments. The filter element of the present invention can be designed to fit the housing configuration, and once designed and manufactured, the filter element provides for flexibility not available with prior art. Furthermore, the filter element is designed in a desired form and mounted in the housing in a way that does not allow the escape of the smoke and the arrangement of the fans does not allow the re-entry of the smoke back to the chimney, a criticism that the prior art poses against filtration. The process of the present invention removes the pollutants from the chimneys by using filtration, as disclosed in U.S. Pat. No. 7,318,853 granted to Chung, et al. dated Jan. 15, 2008, which has physical properties that permit it to have resistance to the degrading effects of humidity, heat, air flow, chemical and mechanical stress or impact, as the sole means of air cleaning and this innovation does not use chemicals to combine with other chemicals in order to remove them and does not use water to combine with the chemicals in the gas stream to produce corrosive acids. This process is simple, practical, effective, and inexpensive and makes the present invention possible to be accessible for both industrial and residential chimneys. Furthermore, the present invention is also adaptable to improvement through variations of size and shape of the housing, the numbers of the fans, and layers of filters. For example, the shape of the housing can be rectangular instead of round, and the number of fans and filter layers could increase to make the system even more efficient.

### SUMMARY OF THE INVENTION

The present invention relates to a system for removing pollutants from the smoke emitted from the chimneys. The invention uses three electrical fans and two filters. The first fan draws the smoke from the chimney outlet and pushes it toward the first filter to be cleaned, the second fan draws the partially cleaned air from the first filter and pushes the partially cleaned air toward the second filter to further clean the polluted air and the third fan pushes the cleaned air to the atmosphere.

### DETAILED DESCRIPTION OF THE DRAWINGS

The air pollution control system of the present invention can be applied to an industrial chimney or the chimney on roof of a residential building. The process and apparatus of the present invention will be more fully understood from the following description taken in conjunction with the accompanying figures.

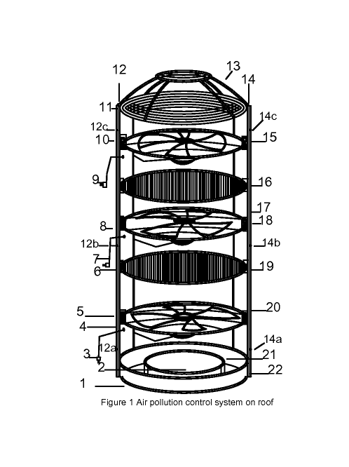

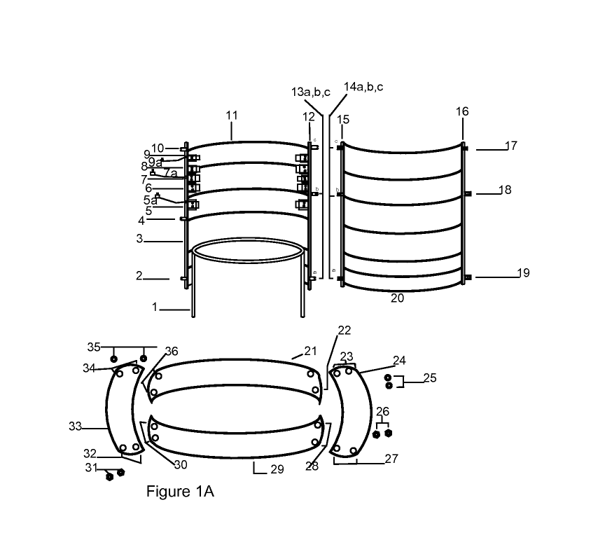

FIG. 1A shows the basic structural elements of the system being mounted on an industrial chimney 1. The rear part of the housing 11 is a semi-circular shape of light-weight metal with two bars 3 and 12 to which the fastening means of fans 5, 7, and 9 and the fastening means of filters 6 and 8 will be attached. Inside the rear part of the housing 11 are installed three fans and two filter means which are securely held in position by the said fastening means. Each of the said fastening means comprises of two metal plates with two holes on each. The lower plate is welded to the body of the said bars 3 and 12 of the rear housing 11. The edge of the fan or the filter means is placed on the said lower plate. The second plate is placed on the said edge of the fan or filter means with the holes of the said two plates aligned. Two screws are passed through the two holes from under the lower plate and two bolts are fastened to the screws on the plate on top to hold the fan /or filter means securely in place. All the three fans and the two filter means are installed in the manner just mentioned.

On the two plates 3 and 12 are installed parts of three locks, 2, 4, 10 on left and 13a,b,and c on right of the rear housing 11 to connect to their corresponding mates 14a, b, and c on left of the cover 37, and 17, 18, and 19 on the right of cover 37 respectively.

On bar 2 there are three holes from which the electrical cords 5a, 7a, and 9a come out to be connected to electrical power, not shown, for the operation of the three fans.

Once the fans and filter elements are installed in the manner mentioned above, the cover 37 can be connected to the rear of the housing 11 and fastened by the locks on both right and left sides. Now the whole housing comprising of the rear of the housing 11 and cover 37 can be installed on top of the chimney

Although the housing is made to fit the size of the chimney, extra tightening of the housing to the chimney is necessary to make the operation of the system quite secure at a high altitude. Therefore, the other components shown in FIG. 1A are used.

The components for securing the housing on the chimney comprises of four plates each with four holes in the four corners. Plate 21 embraces the rear part of the housing 11 and the chimney to connect to the front plate 29, the latter embracing the cover 37 and the chimney from the front. These two plates, 21 and 29, are connected to each other by means of two other plates 33 and 24 on left and right side of the housing. To connect the rear plate 21 to the front plate 29 on left, the two screws 35 pass through the two holes 34 of the left side plate 33 and through the two holes 36 of the rear plate 21, through the two holes 30 of front plate 29, and then through the two hole 32 of side plate 33 in front. To complete the connection on left, the two bolts 31 are tightened to the screws 35 on the holes 32 on the face of the side plate 33. The same procedure is followed for the connection of the right side of the housing. The two screws 25 pass through 23 from rear, then through 22, 28, and finally 27, and then the two bolts 26 are tightened on the face of 27.

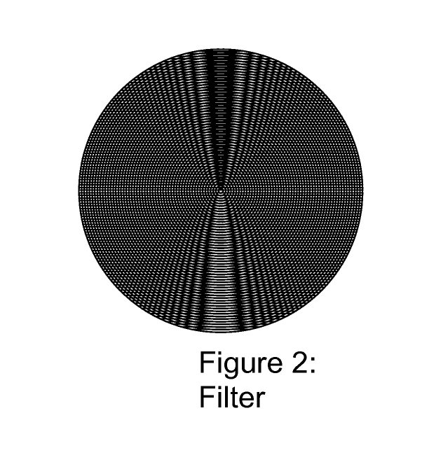

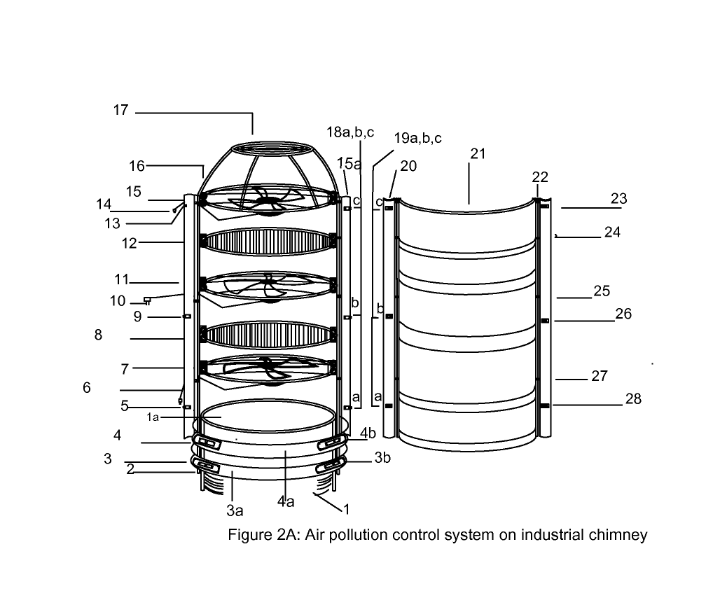

FIG. 2A shows the housing 12 with fans and filter means installed inside it. To show that other ways are available for mounting the housing 12 on the chimney 1, FIG. 2A shows two brackets 3a, 4a embracing the housing 12 and the chimney 1 together. The housing 12 is put on top of the chimney 1 allowing the chimney's top part to enter the housing for two to three feet to insure a secure placement. The number 2 in the figure shows the extent that the chimney has entered the housing 12. Two brackets 3a and 4a embrace the housing like a belt and are tightened by means of tension locks 3 and 4 on left and 3b and 4b on right side of brackets 3a and 4a to tighten the housing 12 to the chimney 1.

With the fans and filter means installed, the cover 21 can be attached to the housing 12. The cover 21 covers the housing 12 only from the point above bracket 4a.

The cover 21 is, therefore, not attached to the chimney and can be removed for cleaning and/or replacement of fans and filter elements, the inside of the housing and/or of itself. Furthermore, for cleaning and/or replacement purposes, the cover 21 does not have to be removed; it can, alternatively, be opened and pushed to the side on the hinges 24, 25 and 27 provided on right side of the cover 21 and on the left side, not numbered. To attach the cover 21 to the housing 12 or remove it from the latter is very easy. To attach, the lock part on plate 20 connect to lock parts on plate 15 and the lock parts on plate 24 connect to lock part on plate 15a. There fore, 19c should mate with its fellow 13, 19b with 9 and 19a with 5 to complete the attachment on the left side. For the right side, the lock part 23 should mate with 18c, 26 with 18b and 28 with 18a.

To start the operation, the three electrical cords 6, 10, and 14 have to be connected to a power source, not shown, and turned on. The smoke containing the pollutants exits the chimney outlet 1a and is pulled by the fan 7 and is pushed upward by the same fan toward the first filtering means 8, the said filtering means 8 absorbs the pollutants in the smoke. The fan 11 pulls away the partially cleaned air to itself and pushes the said air toward the filtering means 12 which cleans the partially cleaned air further. The cleaned air is sucked by the fan 16 and is pushed by the said fan to outlet 17 of the housing to enter the atmosphere.

FIG. 1 shows the housing with fans and filter means installed on a residential roof. As can be seen in the figure, the mechanism for cleaning the polluted air exiting from the chimney outlet 2 is the same as the one used for the industrial chimney previously discussed. The installation of the housing is even much easier because it is placed on a flat roof and it does not need the holding bracket and locks used for the industrial chimney. to keep the system steady and safe against strong winds, the base 1 of the system is made of a solid metal to firmly stand on the roof and strong enough to support the weight of the fans and filters means. The height of the base 1 is about one foot from the floor of the roof 22, and the base's top part is lower than the edge of the chimney 21.

FIG. 1 also shows the three electrical cords 3, 7, and 9 to be connected to a power source, not shown. FIG. 1 also shows how the three fans, not numbered, are attached, in the housing, to the brackets 5, 20, 8, 18, 10 and 15. FIG. 1 does not show the cover of the housing which functions as a door, because its design and structure are the same as shown in FIG. 2A previously discussed, but the cover begins from the top part of the base 1 and ends at the outlet of the housing indicated by number 11.

The cover can be attached to the housing by locks 12a, 12b and 12c on left and 14a, 14b, and 14c on right placed on plates 4 and 17 respectively. These mentioned locks mate with their corresponding part on the cover not shown. The plates 4 and 17 are connected to the body of the housing by bars 12 and 14 which allow the cover to open to the side for cleaning of the interior of the housing, cleaning and/or replacement of the fans and filter means.

As can be seen in FIG. 1, each filter element is tightened by one screw and one bolt on each side, 6, 19, 16 and its unnumbered counterpart on left, whereas the fans, due to their weight and rotational movement, are tightened by two screws and two bolts on each side, 5, 8, 10 on left and 20, 18, and 15 on right. The top part of the housing is covered by a cover 13, whose sides are closed to prevent entry of rain from the sides and the cleaned air exits from the upper top part. In FIG. 1 the sides of the top cover 13 are not covered to show the interior from where the cleaned air exits.

FIG. 2 shows a polymer micro fiber as disclose in U.S. Pat. No. 738853 and granted to Chung on Jan. 15, 2008. It is designed to fit the shape of the housing in a way that no room is left for the smoke to escape before being cleaned.

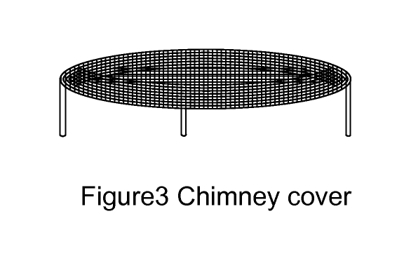

FIG. 3 shows a screen designed to prevent the entry of large particles into the housing. This screen is not necessary for the residential chimney.

What is claimed is:

1. The only claim of this invention is an air pollution control system for removing pollutants from industrial and/or residential chimneys comprising: (a) an elongated cylindrical metal barrel-like hollow housing disposed with its longitudinal axis extending vertically, (b) said housing having an inlet end securely attached to the outlet of the chimney, and an outlet end from which the cleaned air exits; (c) a pair of brackets embracing the said housing and the chimney and holding securely the said housing to the chimney through tension locks; (d)fans and filters support means disposed in the said housing to securely hold three fans and two removable filters; (e) three fans mounted in the housing creating a primary airflow within the enclosed space of the said housing, the first fan of the three fans is placed close to the inlet part of the housing to draw the smoke from the chimney outlet and force the smoke toward the first filter mounted after the first fan; a second fan draws the partially cleaned air from the first filter and forces the partially cleaned air toward the second filter which absorbs the remaining pollutants; a third fan draws the cleaned air from the second filter and expels the cleaned air into the atmosphere; (f)the said housing has a door-like cover to open for cleaning the fans, the interior of the housing, and/or replacing the filters.
